(19) United States
(12) Patent Application Publication
(10) Pub. No.: US 2004/0070981 A1
(43) Pub. Date: Apr. 15, 2004

(54) Hat lamp shades

(76) Inventor: Donna M. Long, Baltimore, MD (US)

Correspondence Address: Walter A. Reiter, III, Esq., 170 West Street, Annapolis, MD, 21401, US

(21) Appl. No.: 10/269,506

(22) Filed: Oct. 12, 2002

(51) Int. Cl. F21V 11/00

(52) U.S. Cl. 362/353; 362/359; 362/806

(57) ABSTRACT

A decorative lamp shade design element for use with a table or floor lamp, a ceiling or wall mounted lighting fixture or other lighting fixture where the shade is comprised of a man's or woman's dress or casual hat with a suspension mechanism mounted within the hat such that the hat shade is so positioned over the lighting element as to shade and direct the light from the element in a pleasing and useful manner.

### FIELD OF THE INVENTION

The present invention relates to a lampshade comprised of man's or woman's hat with a suspension mechanism attached to the interior of such hat projecting from the inside perimeter of the crown of the hat forming an attachment point or points such that the hat can be secured over a light bulb or other lighting element of a lamp or lighting fixture held suspended away from the lighting element such that the hat functions as a shade.

### BACKGROUND OF THE INVENTION

The present invention relates to the decorative use of a man or woman's dress hat as a lampshade. The hat shade is to be used as an item of design intended to add style, flair and visually intriguing and appealing image when used in place of and as a shade for a table, floor, wall mounted, suspended or other manner of lighting fixture. The hat thus modified to be suitable and capable of use as a shade would create a useful and functional shade but also a stylish, intriguing and whimsical design element.

From time immemorial up until the late 1950's and early 1960's the hat was an essential and ubiquitous fashion accessory. The man's hat defined everything from style and station to profession and avocation. The woman's hat in its myriad of types and styles is the most creative, expressive and prominent fashion accessory available. One of the only common features of the dress hat over the years has been that it is so dimensioned to fit over a human head and thus defines a cavity of roughly similar bowl like dimension.

It is this bowl like nature, defined by the interior dimension of the hat that renders the present invention functional. That is when a light bulb or similar illuminating element is fixed such that the interior of the hat is equally distal in all directions from the bulb that the hat, so suspended, functions as a lampshade.

The hats' nostalgic standing as an artifact of times frequently romanticized makes the hat a most powerful design element. Hats are prominent in art, cinema, literature and history.

The subject of the current invention is the reincarnation of the hat as a design element to be used in interior design. The current invention revitalizes the hat as a visual accouterment by displaying the hat as a lampshade. Not only does the hat as shade satisfy the practical function of the shade, more specifically directing the rays of the lighting element away from the eye, but it also recaptures the hat as a design element, evoking the style of the period associated with the particular hat so utilized.

The use of lampshade is well known in the prior art. As set out below, the prior art describes lamp shades that collapse, lampshades that glow, lampshades that spin, lampshades shaped so that they fit neatly into interior corners and lampshades that adjust. These devices fulfill their varied intended purposes but they do not make the decorative and stylistic statement that the present invention accomplishes.

U.S. Design Patent 173,512 Lamp or Similar Article by Sidney Rubeck, claims a lamp the base of which is a Roman Helmet.

U.S. Design Patent 226,676 Lamp by Edward Stevens, claims a lamp the base of which is two baseball-sized spheres stacked horizontally supporting the light bulb. The shade of this lamp is a baseball batting helmet.

U.S. Design Patent 289,694 by James Pickett Jr. is a lamp, ornament and container that has mounted on top of the lamp, above the shaed and not forming part of the shade, a football helmet.

U.S. Design Patent 311,594 by Christopher J. Medina is an ornamental design for a flashlight wherein the body of the flashlight is a football helmet.

U.S. Design Patent 321,845 by Peter Nys is a football helmet mounted on a stand.

U.S. Design Patent 360,272 by Yuan-Shyuam Chur is a desk lamp comprised of a base in the shape of home plate, a stem in the shape of a bat and a shade mounted on top of the bat in the shape of a baseball cap.

U.S. Design Patent 375,810 by Byung L. Ham is a night light in the shape of a football helmet.

U.S. Pat. No. 5,605,391 by Peter M. Woods Convection Rotated Ornament claims a spinning incandescent bulb cover. The invention has a shade portion and a spinning turbine vane portion. The heat from the lamp causes the shade to spin as the rising air currents pass over the vanes.

U.S. Pat. No. 5,833,349 by Wayne B. Apple, Phosphorescent Lamp Shade claims a lamp having a lamp shade that phospheresces after the light from the bulb uis extinguished. The glowing lamp shade provides a low level of light for twenty to thirty minutes after the bulb is extinguished.

U.S. Pat. No. 6,079,855 by Ruth Ann Azeredo. Detachable Decorative System for Lamp Shades claims a decorative system for lamp shades and related articles that relies upon a plurality of spring tensioned clips to attach a decorative device to a lamp shade.

U.S. Pat. No. 6,095,664 by Yu-Ting Wang, Ornamental Lamp claims an ornamental lamp having a lamp bulb, and an ornament directly molded from a polymer around the bulb of the lamp bulb and colored, permitting the lamp base of lamp bulb to be extended out of the ornament for connection to an electrical socket.

U.S. Pat. No. 6,435,700 B1 by Michael Graham, Adjustable Lamp Shade claims an adjustable lamp shade for use in association with a table lamp with a threaded upper bolt and a light source, the apparatus comprises a center support formed of a plurality of rods, a cross plate with a centrally positioned aperture being coupled to the center support; and a shade frame being coupled to the rods of the center support by the clips, the clips allowing a user to swivel each panel of the shade frame independently of the other panels, in an operative orientation a user raising a single panel of the shade frame in order to direct light in a specific direction.

U.S. Pat. No. 6,439,747 B1 by Yi-Shun Liu Lamp Shade Folding Structure claims a lampshade folding structure to achieve minimum packing volume thus to reduce the costs of packing material and transportation essentially comprised of a support frame to stretch up a soft shade between an upper and a lower rings; each ring provided with at least two pivoting devices so that when folded into a semi-circular shape and put on the same plane with the support frame removed to facilitate packaging, transportation, carriage and storage.

### SUMMARY OF THE INVENTION

The purpose of the invention is to provide a distinctive and functional decorative accessory to a lighting fixture by forming a shade for that lighting fixture from man's or woman's dress hat. In addition to providing a decorative element, the hat shade also functions to shade the light from the lighting element such that it does not shine unpleasantly in the eyes of those nearby but also such that the light is directed in a pleasing and useful direction such as towards a painting on the wall, a ceiling, or down upon stair, floor, or table top.

To achieve this effect, a lady's or man's dress hat is rendered suitable for use as a lamp shade by attaching to the hat a suitable suspension mechanism to attach the hat to a lighting fixture such that the lighting element lies an equidistance, more or less, from the interior perimeter of the hat or centrally within the cavity formed by the hat. The suspension mechanism must also hold the material of the hat in distal proximity from the lighting element to avoid undue transmission of heat from the element to the material comprising the hat.

The suspension mechanism thus attached to the interior of the hat also attaches to either the lighting fixture or the light bulb.

### BRIEF DESCRIPTION OF THE DRAWINGS

The invention will be better understood and objects other than those set forth above will become apparent when consideration is given to the following detailed description thereof. Such description makes reference to the annexed drawings herewith:

FIG. 1 is a perspective side view of the preferred embodiment of the hat shade applied and attached to a table lamp.

FIG. 2 discloses a cut away side view of the preferred embodiment showing the hat shade attached to a table lamp, the suspension mechanism and the lighting element in proximity to the interior of the hat shade.

FIG. 3 is a cut-away view of a hat shade showing the suspension device in perspective inside the hat shade.

FIG. 4 is a perspective view of the suspension device.

FIG. 5 is a side perspective of a table lamp with the suspension device in place and attached to the light bulb of the table lamp.

FIG. 6 is a side perspective of a hat shade comprised of a lady's dress hat in place upon a table lamp.

FIG. 7 is a perspective view of the suspension device.

FIG. 8 is a perspective view of the interior of a hat shade with the suspension device in place.

FIG. 9 is a perspective view of a hat shade with the suspension mechanism in place and with a light bulb secured into the suspension mechanism.

### DESCRIPTION OF THE PREFERRED EMBODIMENTS

Referring now to the drawings, the preferred embodiments of the hat shade will be described.

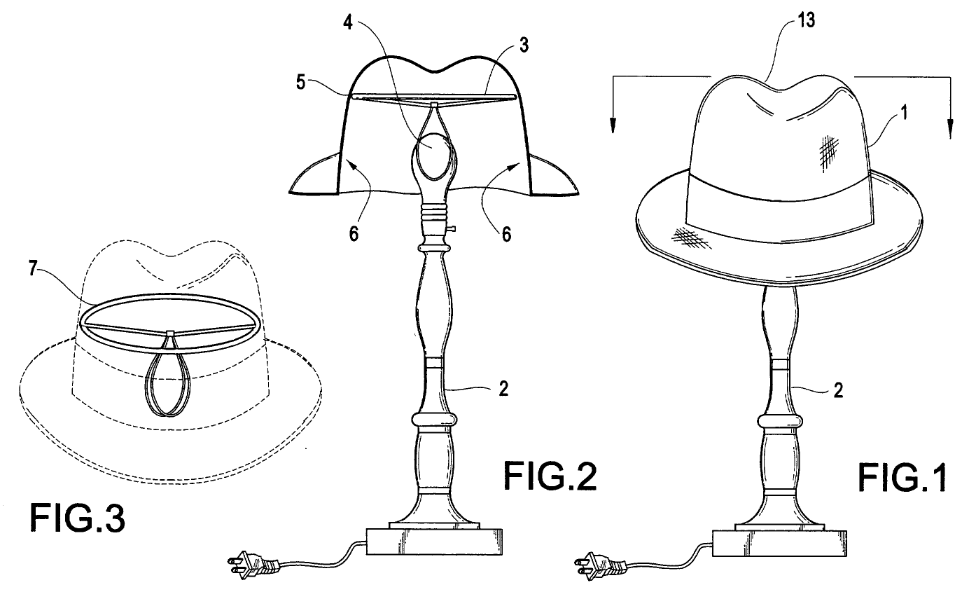

Specifically, FIG. 1 shows a man's dress hat 1 position on and functioning as a shade for a common table lamp 2. The hat 1 extends down upon the lamp 2 to a point such that the light bulb is not visible and the light emitted therefrom would be shield from directly shining into ones' eyes.

FIG. 2 shows the same configuration as FIG. 1 but with the hat shade in cross section thus exposing to view the suspension mechanism 3. The suspension mechanism clamps onto the light bulb 4 and extends upward and then distally outward to the base of the crown of the hat at a point 5 thus suspending the hat shade over the light bulb creating a gap between the interior sides of the hat 6 and the light bulb 4.

FIG. 3 shows the suspension mechanism in cut away perspective view as it is mounted to the interior of the hat shade. Such suspension mechanism in this preferred embodiment forms a circular support coextensive with the interior crown of the hat shade 7.

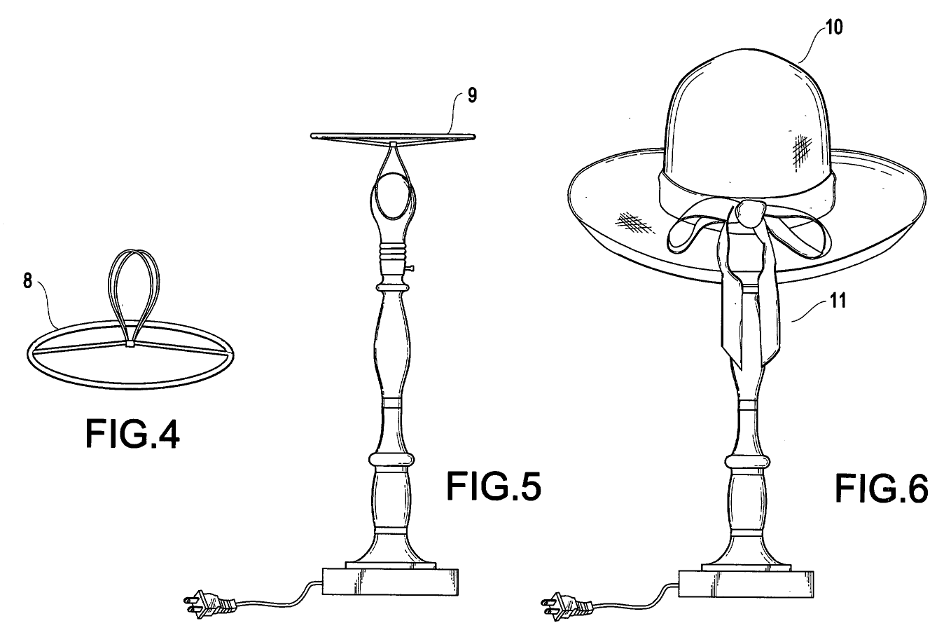

The preferred embodiment of the suspension mechanism is shown in FIG. 4 in an inverted fashion 8 from its preferred embodiment as a shade mounted on a vertically oriented table or floor lamp 9 as shown in FIG. 5. However, since the suspension mechanism is not dependant upon gravity to accomplish the attachment to the light fixture, the suspension mechanism and thus the hat shade would also be capable of being attached to a lighting fixture of orientations other than vertical. More specifically, the hat shade is capable of attachment to a ceiling mounted fixture or a wall mounted fixture.

FIG. 6 shows an additional preferred embodiment wherein the style of dress hat 10 is representative of a woman's dress hat as opposed to a traditional man's hat as depicted in FIG. 1. As depicted in FIG. 6, the proffered embodiment of the hat shade positions the lower edge of the hat at a point below the horizontal plane of the lower edge of the light bulb 11.

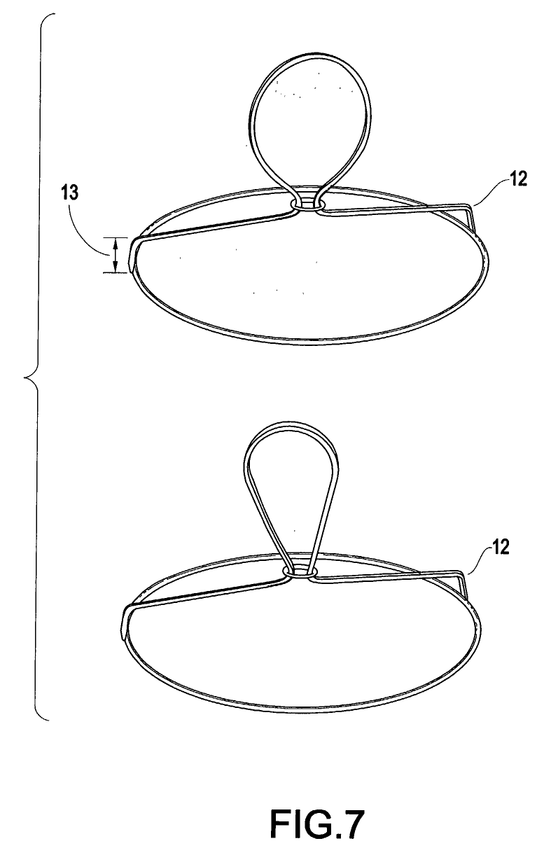

FIG. 7 is two perspective views of the suspension mechanism showing an additional preferred embodiment comprising an angled extension to the cross piece whereby the crown of the hat shade will be held a greater distance 13 from the bulb to accommodate hat styles with a low crown 13 as shown in FIG. 1.

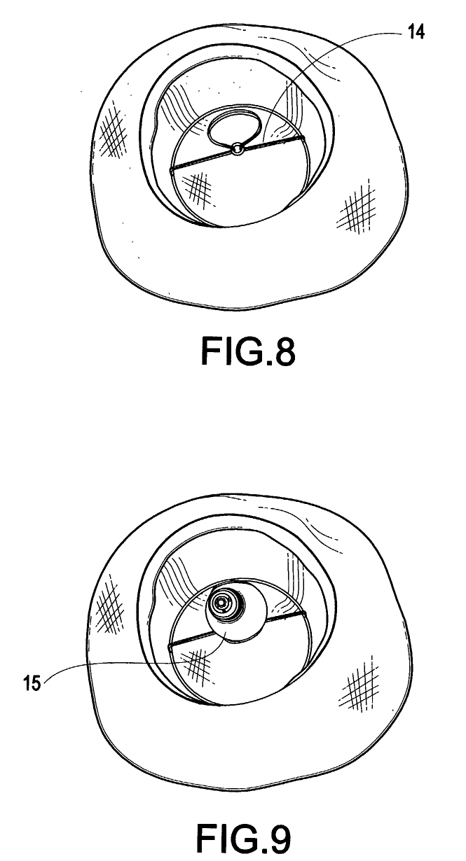

FIG. 8 is a perspective view of the underside of a hat shade showing the inverted hat shade with the suspension mechanism in place and attached to the underside of the crown of the hat shade 14. FIG. 9 shows the same perspective view as FIG. 8 but also shows the suspension mechanism attached to a light bulb 15 and the spatial relationship of the light bulb to the interior of the hat shade. It is an additional feature of the preferred embodiment that the light bulb or light fixture be held a distance from the surface of the shade such that the heat from the light bulb will not ignite or discolor the material comprising the hat shade.

I claim:

1. A hat shade for use in shading the light from a table, floor, wall mounted or suspended light source, said lamp shade comprising:
a. a hat,
b. a suspension mechanism attached to the interior of the hat so that the hat is suspended in relation to the light source such that the light is directed or shaded in a manner that is not irritating to the eyes of people in proximity to the light.

2. Said suspension mechanism further comprised of a roughly circular frame, a transverse member mounted across the diameter of said circular frame and said transverse member forming a method of attaching to a light bulb or other light emitting element by clamping, in a detachable manner, onto the bulb.

3. The hat shade of claim 1 wherein the hat is a man's hat.

4. The hat shade of claim 1 wherein the hat is a woman's hat.

5. The hat shade of claim 1 wherein the hat is a child's hat.

6. The hat shade of claim 1 wherein the hat is helmet.
